(19) United States
(12) Patent Application Publication
(10) Pub. No.: US 2008/0131736 A1
(43) Pub. Date: Jun. 5, 2008

(54) Longitudinal magnetic recording medium and storage having the same

(75) Inventors: Kazuhisa Shida, Higashine-shi (JP); Yuki Yoshida, Higashine-shi (JP); Jun Taguchi, Kawasaki (JP); Noriyuki Asakura, Higashine-shi (JP); Akira Kikuchi, Higashine-shi (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/901,315

(22) Filed: Sep. 17, 2007

(30) Foreign Application Priority Data
Nov. 30, 2006 (JP) 2006-324778

(51) Int. Cl. G11B 5/66

(52) U.S. Cl. 428/831

(57) ABSTRACT

A longitudinal magnetic recording medium includes, in order from a nonmagnetic substrate, a primary coat layer that contains Cr, an intermediate layer, a magnetic layer as a recording layer made of CoCr alloy, and a protective layer, the intermediate layer including a RuCr intermediate layer made of a RuCr alloy that contains 10 to 50 at % of Cr.

This application claims the right of a foreign priority based on Japanese Patent Application No. 2006-324778, filed on Nov. 30, 2006, which is hereby incorporated by reference herein in its entirety as if fully set forth herein.

### BACKGROUND OF THE INVENTION

The present invention relates generally to a longitudinal magnetic recording (“LMR”) medium in which a direction of an easy axis of magnetization (or the magnetization direction) is parallel to a recording surface, and more particularly to a lamination structure of the LMR medium. The present invention is suitable, for example, for a structure of a magnetic disc mounted in a hard disc drive (“HDD”).

Recently, demands for a higher recording density, stable recording and reproducing of a magnetic disc mounted in the HDD have increasingly grown. For the stable recording and reproducing, thermal fluctuations and signal noises need to be restrained. The thermal fluctuation is a phenomenon in which a magnetic particle cannot maintain its magnetic axis in one direction due to the external heat influence. The energy to maintain the magnetic direction in one direction is in proportion to the volume and anisotropy of a magnetic particle. A high surface recording density magnetic disc has a small magnetic particle, the heat energy that destroys the magnetization direction is no longer negligible. Hence, the thermal fluctuation should be restrained. The signal noise is particularly important under a demand for high-speed transmissions.

One conventional LMR medium includes, in order from a nonmagnetic substrate, a primary coat layer containing Cr, an intermediate layer, a magnetic layer as a recording layer made of a CoCr alloy, and a protective layer. The conventional intermediate layer includes, in order from the nonmagnetic substrate, an intermediate layer made of a CoCr alloy (“CoCr intermediate layer” hereinafter) and a genuine ruthenium (“Ru”) intermediate layer. The Ru layer is a nonmagnetic coupling layer that serves to restrain the thermal fluctuation.

Prior art includes, for example, Japanese Patent Applications, Publication Nos. 2001-56924 and 2001-283428, Japanese Patent No. 3,421,632, and Binary Alloy Phase Diagrams, 2nd Edition, Edited by T. B. Massalski, H. Okamoto, P. R. Subramanian, L. Kacprzak (1990), Volume 2, p. 1323.

As the recording density becomes higher, the signal noise of the magnetic disc becomes conspicuous. The signal noise depends upon the crystalline unconformity, which depends upon the grating-size unconformity. It is generally preferable that the grating size increases from the nonmagnetic substrate and the recording layer.

When the instant inventors investigated the grating size in the conventional magnetic recording medium, the grating size of the genuine Ru intermediate layer has a grating size of 2.34 Å in the crystal orientation d (1 0 0), and a grating size of 2.13 Å in the crystal orientation d (0 0 2). On the other hand, the recording layer adjacent to and above the genuine Ru intermediate layer has a grating size of 2.26 Å in the crystal orientation d (1 0 0), and a grating size of 2.10 Å in the crystal orientation d (0 0 2). Thus, the conventional magnetic recording medium is configured so that the grating size gradually increases from the nonmagnetic substrate to the genuine Ru intermediate layer in a direction from the nonmagnetic substrate to the recording layer, but the grating size decreases from the genuine Ru intermediate layer to the recording layer.

### BRIEF SUMMARY OF THE INVENTION

The present invention is directed to a LMR medium that provides stable recording and reproducing actions by restraining the thermal fluctuations and signal noises.

A LMR medium according to one aspect of the present invention includes, in order from a nonmagnetic substrate, a primary coat layer that contains Cr, an intermediate layer, a magnetic layer as a recording layer made of CoCr alloy, and a protective layer, the intermediate layer including a RuCr intermediate layer made of a RuCr alloy that contains 10 to 50 at % of Cr. When the Cr load is below 10 at %, the improvement of the signal noise becomes insufficient. When the Cr load exceeds 50 at %, the crystal structure cannot stably maintain the hexagonal close-packed structure (“hcp”).

Preferably, the RuCr intermediate layer is made of the RuCr alloy that contains 25 to 36 at % of Cr. When the Cr load is above 25 at %, the signal noise improvement becomes maximum. When the Cr load is below 36 at %, a deterioration of the thermal fluctuation resistance can be restrained, and the crystal structure can be stably maintained to the hcp. Preferably, the RuCr intermediate has a thickness between 1.0 nm and 2.5 nm. This range can effectively restrain the signal noise. The RuCr intermediate has 25 at % of Cr, and the intermediate layer further includes a ferromagnetic layer that is arranged closer to the nonmagnetic substrate than the RuCr intermediate layer and has a thickness between 1 nm and 4 nm. It is confirmed that this range can effectively restrain the signal noise.

A LMR medium according to another aspect of the present invention includes, in order from a nonmagnetic substrate, a primary coat layer that contains Cr, an intermediate layer, a magnetic layer as a recording layer made of CoCr alloy, and a protective layer, the intermediate layer being a lamination of a layer that contains Co and a layer that contains RuCr, and the layer that contains Co being coupled with the recording layer via the layer that contains RuCr in an antiferromagnetic manner.

A storage having the above LMP medium also constitute one aspect of the present invention.

Other objects and further features of the present invention will become readily apparent from the following description of the preferred embodiments with reference to accompanying drawings.

### BRIEF DESCRIPTION OF THE DRAWINGS

FIG. 1 is a schematic view showing a lamination structure of an LMR medium.

FIG. 2 is a graph showing a relationship among the Cr load in the RuCr intermediate layer, the signal noise, and the thermal fluctuation resistance in the LMR medium shown in FIG. 1.

FIG. 3 is a graph showing a noise reduction when the RuCr intermediate layer in the LMR medium shown in FIG. 1 is compared with the genuine Ru intermediate layer.

FIG. 4 is an alloy phase diagram.

FIG. 5 is a SN ratio characteristic of a magnetic disc when a film thickness of a RuCr intermediate layer is varied in a Cr load range between 10 at % and 40 at %.

FIG. 6 is a graph showing a relationship between a film thickness of the CoCr intermediate layer (ferromagnetic layer) shown in FIG. 1 and the SN ratio.

FIG. 7 is an internal structure of a HDD having the LMR medium shown in FIG. 1.

### DETAILED DESCRIPTION OF THE PREFERRED EMBODIMENTS

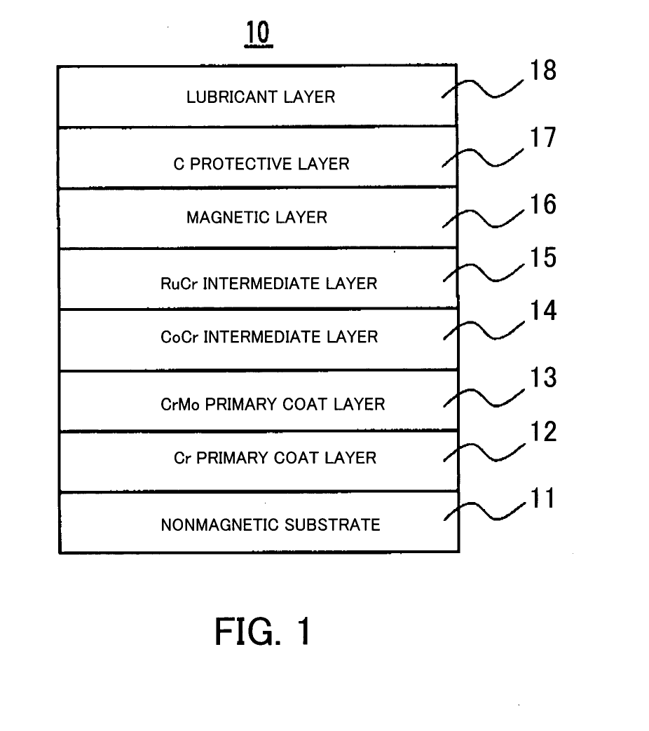

FIG. 1 is a schematic view showing a lamination structure of a LMR medium (magnetic disc) 10 of this embodiment. The magnetic disc 10 has, in order from a nonmagnetic substrate 11, a Cr primary coat layer 12, a CrMo primary coat layer 13, a CoCr intermediate layer 14, a RuCr intermediate layer 15, a magnetic layer (recording layer) 16, a carbonic protective layer 17, and a lubricant layer 18. The magnetic disc of this embodiment 10 is characterized in replacing the conventional genuine Ru intermediate layer with a RuCr intermediate layer 15.

The nonmagnetic substrate 11 is made of glass or aluminum. The Cr primary coat layer 12 is used to crystal growth of the hcp layers (i.e., layers 14 to 16). The CrMo primary coat layer 13 also serves as the Cr primary coat layer 12, but adjusts the grating size conformity because Mo is added and the grating size increases.

As proposed by in Japanese Patent Application No. 2006-266078 assigned to the same assignee of this application, the primary coat layer preferably has three or more Cr alloy primary coat layers that contain Cr, Mo, Ti, W, V, Ta, Mn and B, and an upper primary coat film (e.g., the primary coat layer 13) has more elements other than Cr than a lower primary coat film (e.g., the primary coat layer 12). In addition, the Cr primary coat film 12 preferably has a thickness of 10 nm or smaller.

The CoCr intermediate layer 14 is a ferromagnetic layer, and serves to adjust the crystal orientation and the grating size conformity before the magnetic layer 16 is formed. As proposed by in Japanese Patent Application No. 2006-266078, the ferromagnetic layer is preferably made of an alloy that has a main ingredient of Co, and contains at least one of Cr, Ta, Mo, Mn, and B.

The RuCr intermediate layer 15 improves the thermal fluctuation resistance and adjusts the grating size conformity through Ru. This embodiment replaces the conventional genuine Ru intermediate layer with the RuCr alloy. The RuCr intermediate layer 15 can be manufactured by a known alloy manufacturing apparatus.

The intermediate layer of this embodiment includes a pair of the CoCr intermediate layer 14 and the RuCr intermediate layer 15, but the number of pairs is not limited. For example, the intermediate layer may include a CoCr intermediate layer, a RuCr intermediate layer, a CoCr intermediate layer, a RuCr intermediate layer . . . .

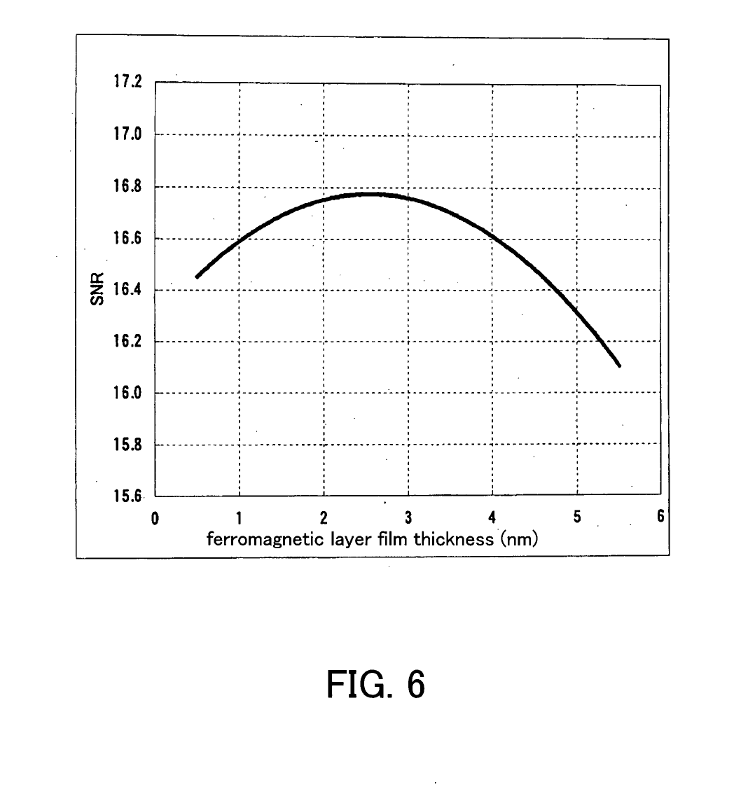

The CoCr intermediate layer 14 preferably has a thickness between 1 nm and 4 nm. When the thickness of the CoCr intermediate layer 14 is varied as shown in FIG. 6 relative to the Ru-25Cr intermediate layer 15, the SN ratio (“SNR”) improves in a range between 1 mm and 4 mm. Here, FIG. 6 is a graph showing a signal noise characteristic when the thickness of the CoCr intermediate layer (ferromagnetic layer) 14 is varied.

The magnetic layer 16 is made of a CoCrPt alloy. The C (carbonic) protective layer 17 protects the magnetic layer 16 from oxidation. The lubricant layer 18 is made of polymer, and protects the magnetic layer 16.

The instant inventors have tried a grating size reduction of the intermediate layer by adding a smaller material than the Ru's grating size to the conventional genuine Ru intermediate layer.

It is assumed that Cr has a body-centered cubic lattice (“bcc”) structure, and destroys a crystal structure when Cr is added to Ru or the crystal structure cannot maintain the hcp and would become the bcc. When the crystal structure destroys, the magnetization direction does not accord with the surface of the magnetic layer 16 or the longitudinal direction, causing unstable recording and reproducing. On the other hand, Co has the hcp similar to Ru. According to the experiment by the instant inventors, it was confirmed that the grating size of the Co-added Ru intermediate layer reduced, and the SNR improved. See Japanese Patent Application No. 2006-266078.

As a result of additional experiments and investigations, the instant inventors discovered that the RuCr alloy that contained 10 to 50 at % of Cr more effectively reduced the signal noises.

### Working Example 1

After the texture process was performed for an Al substrate surface coated with an electroless plated NiP film, a Cr primary coat layer (4 nm), a CrMo primary coat layer (2 nm), a CoCr alloy ferromagnetic layer (2 nm), a Ru-25Cr intermediate layer, a CoCr alloy magnetic layer, and a carbon protective layer were sequentially stacked. Here, Ru-25Cr intermediate layer is a RuCr alloy in which 25 at % of Cr is added to Ru.

A sputtering chamber was exhausted down to 4×10⁻⁵ Pa or below, and the temperature of the substrate 11 was heated up to 220° C. Then, Ar gas was introduced and the sputtering chamber was maintained at 6.7×10⁻¹ Pa, and Cr alloy primary coat layers 12, 13, the CoCr intermediate layer 14, the RuCr intermediate layer 15, the magnetic layer 16, the carbonic protective layer 17, and the lubricant layer 18 were sequentially stacked.

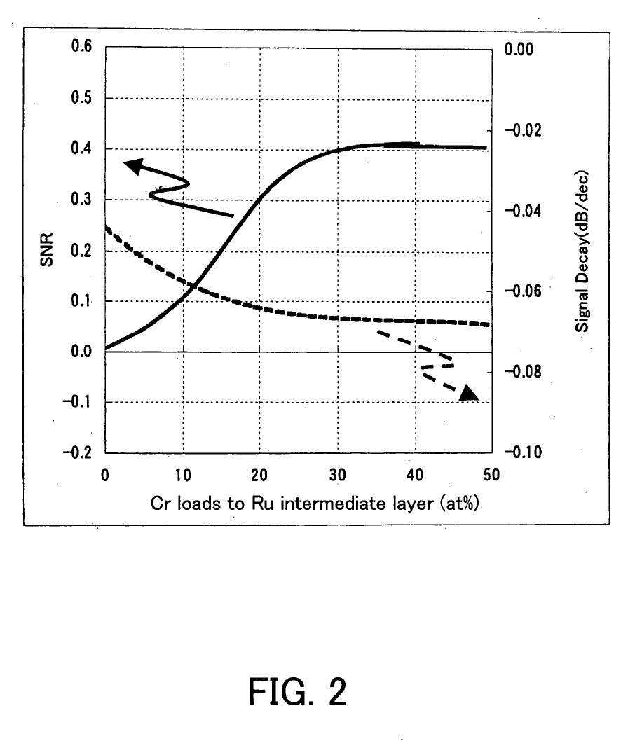

FIG. 2 is a graph of the SNR characteristic of the magnetic disc 10 having a recording density 720 kfci and the thermal fluctuation resistance of the magnetic disc 10 when the Cr load added to conventional genuine Ru used for the intermediate layer 15 was sequentially varied. In FIG. 2, the left ordinate axis denotes the SNR, and corresponds to a solid line in the graph. The right ordinate axis denotes the thermal fluctuation resistance (signal decay), and corresponds to a broken line in the graph. The abscissa axis is the Cr load in the intermediate layer 15. For the thermal fluctuation resistance, the signal decay amount was measured 300 seconds after the signal was written.

When the intermediate layer uses RuCr, the SNR indicated by the solid line gradually improves when use of the genuine Ru intermediate layer is set to zero, the SNR remarkably improves when the Cr load becomes 10 at % or greater and reaches almost the constant (peak) after the Cr load is 25 at % or greater. Thereby, the Cr load is preferably 25 at %.

On the other hand, the thermal fluctuation resistance shown by a broken line decays by about −0.045 (dB/dec) of the genuine Ru intermediate layer, and becomes approximately constant as about −0.068 (dB/dec) after the Cr load is 36 at % or greater. Thereby, the Cr load is preferably 36 at % or smaller.

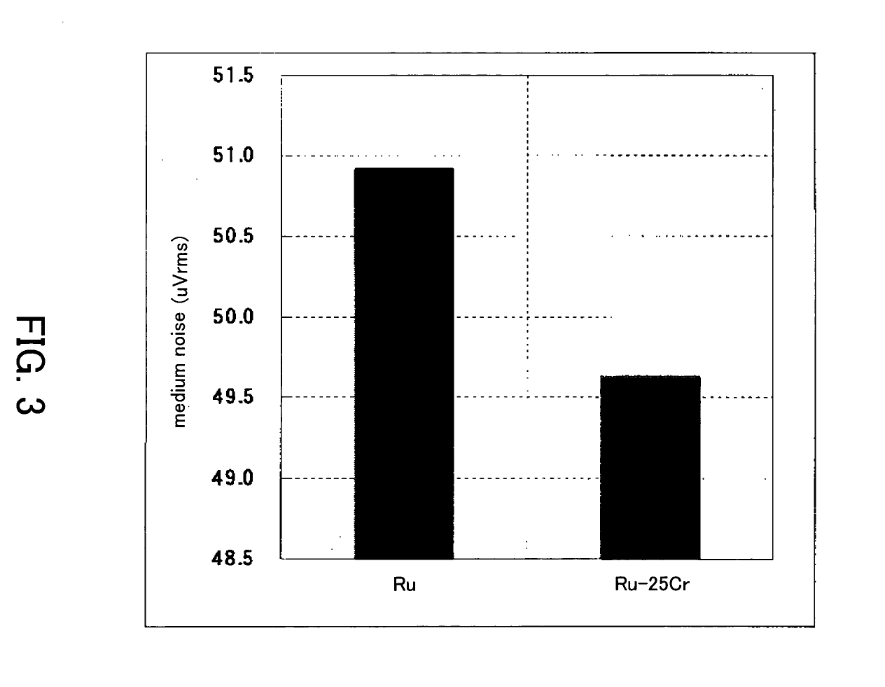

FIG. 3 is a graph that compares the magnetic disc having the conventional genuine Ru intermediate layer with the magnetic disc according to this embodiment that has the Ru-25Cr intermediate layer 15. FIG. 3 shows a noise characteristic of the magnetic disc having a recording density of 720 kfci. Use of the Ru-25Cr intermediate layer can reduce more noises than use of the genuine Ru intermediate layer. The SNR shown in FIG. 2 increases as the signal component increases, but it is understood from FIG. 3 that the noise component itself decreases.

Table 1 indicates the grating sizes (A) of the genuine Ru intermediate layer, the Ru-25Cr intermediate layer, and the recording layer for each crystal orientation. From Table 1, the grating size of the Ru-25Cr intermediate layer is closer to the magnetic layer than the conventional genuine Ru intermediate layer in any crystal orientations. In other words, in the direction from the nonmagnetic substrate 11 to the magnetic layer 16 shown in FIG. 1, the grating size reduction amount from the RuCr intermediate layer 15 to the magnetic layer 16 lessens, improving the crystal grating size conformity. An X-ray diffractometer is used to measure the crystal grating size.

TABLE 1

| | d(1 1 0) | d(0 0 2) |
|---|---|---|
| Genuine Ru Intermediate Layer | 2.34 | 2.13 |
| Ru—25Cr Intermediate Layer | 2.30 | 2.12 |
| Magnetic Layer | 2.26 | 2.10 |

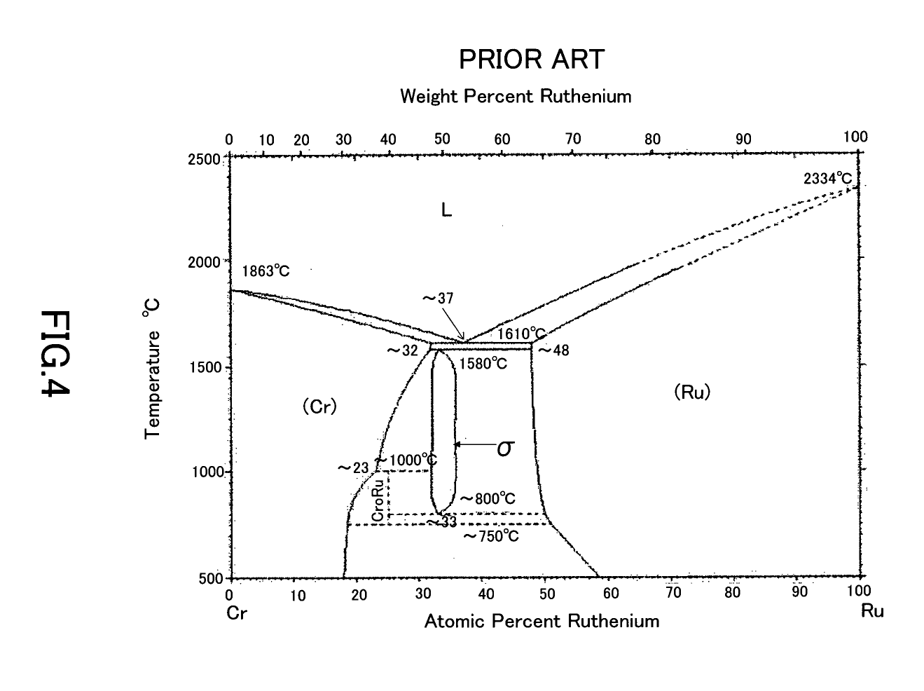

FIG. 4 is a graph showing at % of Ru in the RuCr alloy derived from Massalski et al. above. In FIG. 4, 100 at % at the right side of the abscissa axis corresponds to genuine Ru. As shown in FIG. 4, when a Ru ratio is maller than about 50 at %, Ru's hcp and Cr's bcc mix and the crystal structure becomes unstable. Therefore, the Cr load needs to be 50 at % or smaller. In addition, the mixture region with a low temperature zone extends up to about 58%. Therefore, the Ru ratio is about 58 at % or greater (or the Cr load is 42 at % or smaller).

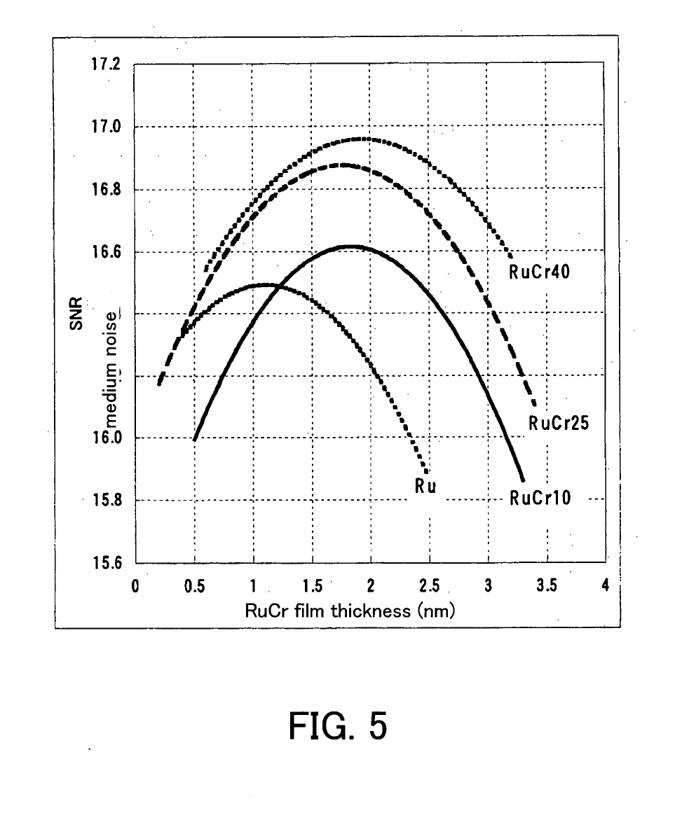

FIG. 5 shows an SNR characteristic of the magnetic disc 10 when the thickness of the RuCr intermediate layer 15 is varied in a Cr load range between 10 and 40 at %. The abscissa axis denotes the thickness of the RuCr intermediate layer 15. Ru-10Cr and Ru-40 Cr mean the Cr loads in the RuCr intermediate layer 15 are 10 at % and 40 at %, respectively. The ordinate axis denotes the SNR. As shown in FIG. 5, the film thickness that improves the SNR of the conventional genuine Ru intermediate layer has a peak between 0.25 nm and 2 nm, whereas the film thickness that improves the SNR of the RuCr intermediate layer 15 has a peak between 0.5 nm and 3 nm, preferably between 1 nm and 2.5 nm.

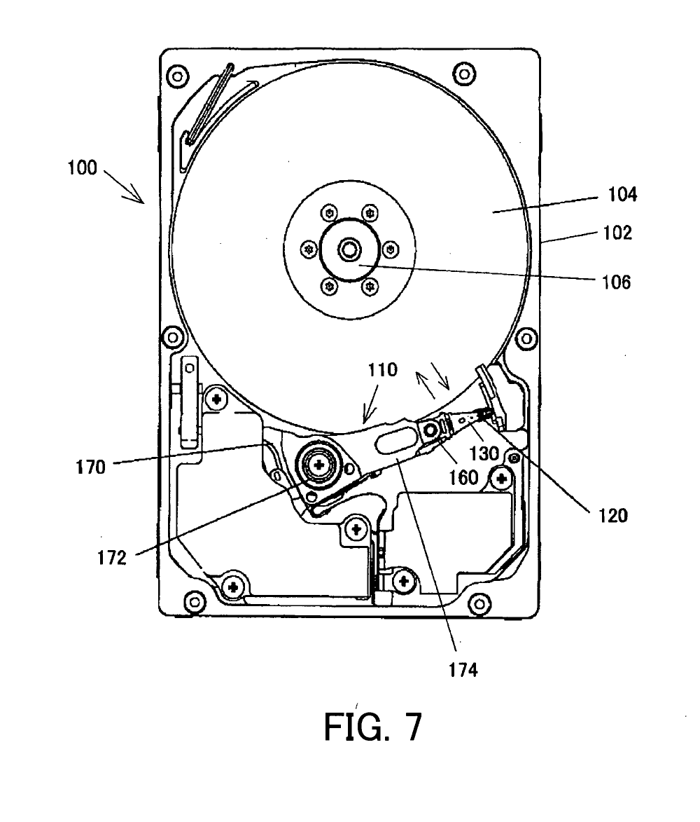

A description will be given of an HDD 100 according to one embodiment. The information storage of this embodiment is implemented as an HDD 100. The HDD 100 includes, as shown in FIG. 7, one or more magnetic discs 104 each serving as a recording medium, a spindle motor 106, and a head stack assembly (“HSA”) 110 in a housing 102. Here, FIG. 7 is a schematic plane view of the internal structure of the HDD 100.

The housing 102 is made, for example, of aluminum die cast base or stainless steel, and has a rectangular parallelepiped shape to which a cover not shown in FIG. 1 that seals the internal space is jointed. The magnetic disc 104 is the LMR disc 10. The magnetic disc 104 is mounted on a spindle of the spindle motor 106 through its center hole of the magnetic disc 104.

The HSA 110 includes a suspension 130 that supports a magnetic head part 120, and a base plate 160, and a carriage 170.

The magnetic head part 120 includes a slider, and a head device built-in film that has a read/write head. The slider supports the head and floats above the surface of the rotating disc 104.

The suspension 130 serves to support the magnetic head part 120 and to apply an elastic force to the magnetic head part 120 against the magnetic disc 104.

The base plate 160 serves to attach the suspension 130 to the arm 174, and includes a welded part and a boss. The welded part is laser-welded onto the suspension 130. The boss is swaged in the arm 174.

The carriage 170 serves to rotate the magnetic head part 120 in arrow directions shown in FIG. 1, and includes a shaft 172, and an arm 174. The shaft 172 is arranged perpendicular to the paper plane in the housing 102 shown in FIG. 1. The central axis of the shaft 172 is a rotating axis of the arm 174. The arm 174 supports the suspension 130 via the base plate 160.

In operation, the slider floats above the magnetic disc 104 and the head provides recording and reproducing. The magnetic disc 104 is the above LMR medium 10, and provides stable recording and reproducing actions because it has reduced thermal fluctuation and signal decay ratio although its recoding density is high.

As discussed above, the magnetic disc 10 forms the primary coat layers (12, 13), the intermediate layers (14, 15), and the magnetic layer 16 on the texture-processed nonmagnetic substrate 11 in the vacuum environment through sputtering. Instead of the conventional genuine Ru intermediate layer, use of the RuCr intermediate layer 15 provides a high SNR and signal maintenance characteristic. The HDD that uses the magnetic disc 10 provides a stable action with a high capacity.

Further, the present invention is not limited to these preferred embodiments, and various modifications and variations may be made without departing from the spirit and scope of the present invention.

What is claimed is:

1. A longitudinal magnetic recording medium comprising, in order from a nonmagnetic substrate, a primary coat layer that contains Cr, an intermediate layer, a magnetic layer as a recording layer made of CoCr alloy, and a protective layer, the intermediate layer including a RuCr intermediate layer made of a RuCr alloy that contains 10 to 50 at % of Cr.

2. A longitudinal magnetic recording medium according to claim 1, wherein the RuCr intermediate is made of the RuCr alloy that contains 25 to 36 at % of Cr.

3. A longitudinal magnetic recording medium according to claim 1, wherein the RuCr intermediate layer has a thickness between 1.0 nm and 2.5 nm.

4. A longitudinal magnetic recording medium according to claim 1, wherein the RuCr intermediate has 25 at % of Cr, the intermediate layer further including a ferromagnetic layer that is arranged closer to the nonmagnetic substrate than the RuCr intermediate layer and has a thickness between 1 nm and 4 nm.

5. A longitudinal magnetic recording medium comprising, in order from a nonmagnetic substrate, a primary coat layer that contains Cr, an intermediate layer, a magnetic layer as a recording layer made of CoCr alloy, and a protective layer, the intermediate layer being a lamination of a layer that contains Co and a layer that contains RuCr, and the layer that contains Co being coupled with the recording layer via the layer that contains RuCr in an antiferromagnetic manner.

6. A storage comprising a longitudinal magnetic recording medium according to claim 1.

7. A storage comprising a longitudinal magnetic recording medium according to claim 5.
